(19) United States
(12) Patent Application Publication
(10) Pub. No.: US 2014/0081886 A1
(43) Pub. Date: Mar. 20, 2014

(54) METHOD OF PROVIDING SECTORIAL DONATION SERVICE FOR SMALL SUM DONOR

(71) Applicants: Sung Je PARK, Busan (KR); Soo Kyo PARK, Busan (KR)

(72) Inventors: Sung Je PARK, Busan (KR); Soo Kyo PARK, Busan (KR)

(21) Appl. No.: 14/028,091

(22) Filed: Sep. 16, 2013

(30) Foreign Application Priority Data
Sep. 14, 2012 (KR) 10-2012-0102492

(51) Int. Cl. G06Q 30/02

(52) U.S. Cl. CPC G06Q 30/0279
USPC 705/329

(57) ABSTRACT

Disclosed is a method of providing a sectorial donation service for a small-sum donor, which is performed using a service provision server that provides a donation service to a donor, the method, comprising: opening a virtual donation foundation for which a donation field and a targeted collection amount are fixed; receiving information about a virtual donation foundation and a collection amount selected and inputted from a user terminal and registering the user as a donor when payment for the contribution amount is completed; selecting a winner among donors when the total amount of contributions reaches the targeted collection amount; receiving information about a beneficiary among donation recipients falling in the donation field of the virtual donation foundation selected in the step (2) inputted from a winner terminal of the selected winner; and (5) performing donation of the collection amount in the name of the winner to the inputted beneficiary.

### CROSS-REFERENCE TO RELATED APPLICATIONS

This application claims the priority of Korean Patent Application No. 10-2012-0102492 filed on Sep. 14, 2012, in the Korean Intellectual Property Office, the disclosure of which is incorporated herein by reference.

### BACKGROUND OF THE INVENTION

1. Field of the Invention

The present invention relates to a method of providing a donation service so as to enable a user of a system capable of implementing the method to make a donation, and more specifically, to a method of providing a sectorial donation service for a small sum donor.

2. Description of the Related Art

In general, a donation is an act of providing money or products without return expectations in order to help charitable work or public work. Recently, as entertainers' or celebrities' donations have become widely known, sharing has become popularized, and it has become possible for donors to conveniently make donations by telephone or via automatic transfer. Due to the above, there is growing awareness of the donations of the general public, and the amount of contributions is gradually increasing.

In the case of regular donations, a donor who regularly gives a certain sum of money to a specific group may feel burdened by the long term commitment. Thus, many donors prefer to make donations irregularly. In many cases of irregular donation, since the amount of one contribution is mainly large, the act becomes a burden to many donors, and when the some donors desire to make small donations an appropriate donation method does not exist. Furthermore, even if the donors make donations in small sums, since it is difficult to specify the donors, there is a limitation in naming the donors and the details of donations or the like cannot be provided to beneficiaries.

On the other hand, since most current donation methods are performed in such a way as to make donations to specific groups, it is in reality difficult for donors to make donations to specific fields desired by the donors. Furthermore, even though the donors may make donations to specific groups, there is a limitation in confirming as to whether or not the amount of contributions is used in fields desired by the donors. Accordingly, in order to vitalize small sum donors' participation in charitable donating and to clarify (to the donor) the fields in which the amount of contributions is used, it is urgent to develop a method of providing a donation service for small sum donors who desire to donate small sums to a specific field.

### SUMMARY OF THE INVENTION

Accordingly, the present invention has been made keeping in mind the above problems occurring in the related art and the present invention is intended to propose a method of providing a sectorial donation service for a small sum donor, which enables a small sum donor to donate a desired sum of money without a burden of contribution and to make a donation to each field by specifying the fields in which the amount of contributions will be used, and which is performed in such a manner that a service provision server opens a virtual donation foundation for which a donation field and a targeted collection amount are fixed, and selects a winner among donors when the total amount of contributions for the virtual donation foundation reaches the targeted collection amount so that the collection amount may be donated in the name of the winner to a beneficiary falling in the donation field.

Another aspect of the present invention provides a method of providing a sectorial donation service for a small sum donor, which can provide the name of a representative donor, namely, the name of a winner, the details of donations or the like to a beneficiary by selecting the winner among small sum donors and making the donation in the name of the winner, and which enables donors who are interested in the same donation field to have high fellowship and to exchange information, and is able to contribute to the spread of a donation culture by providing information about a community service to the donor terminals of donors who make donations to the virtual donation foundation in the same donation field.

In order to achieve the above object, according to one aspect of the present invention, there is provided a method of providing a sectorial donation service for a small sum donor, which is performed by a service provision server that provides a donation service so as to enable a user to make a donation, the method, comprising:

(1) opening a virtual donation foundation for which a donation field and a targeted collection amount are fixed;

(2) receiving information about selection of the virtual donation foundation and a contribution amount inputted from a user terminal and registering the user as a donor when payment for the contribution amount is completed;

(3) selecting a winner among registered donors when the total amount of contributions (hereinafter referred to as, “the collection amount”) reaches the targeted collection amount;

(4) receiving information about a beneficiary among donation recipients falling in the donation field of the virtual donation foundation selected in the step (2) inputted from a winner terminal of the selected winner; and

(5) performing donation of the collection amount in the name of the winner to the inputted beneficiary.

Preferably, the method may further comprise transmitting donation foundation information including information on the donation field and the targeted collection amount of the virtual donation foundation opened in the step (1) to the user terminal, which is performed between the steps (1) and (2).

Preferably, the contribution amount of the step (2) may be less than a predetermined rate of the targeted collection amount.

Preferably, the method may further comprise providing information about a community service for the selected virtual donation foundation to the donor terminals for the donors registered in the step (2) after the step (2) has been performed. Preferably, a probability that one of the donors will be selected as the winner in the step (3) may be proportional to the contribution paid by the donor.

Preferably, in the step (3), user information of the selected winner may be registered in a list of the winners of the virtual donation foundation, and the targeted collection amount may be initialized.

Preferably, in the step (5), a fee may be charged at the predetermined rate of the collection amount, the remaining amount of the collection may be donated in the name of the winner to the beneficiary.

Preferably, the method may further comprise transmitting a confirmation note received from the beneficiary who receives the donation in the step (5) to the donor terminals for the donors registered in the step (2) after the step (5) has been completed.

Preferably, the method may further comprise transmitting a business report received from the beneficiary who receives the donation in the step (5) to the donor terminals of the donors registered in the step (2) after the step (5) has been completed.

In accordance with a method of providing a sectorial donation service for a small sum donor according to one embodiment of the present invention, as the service provision server opens the virtual donation foundation for which the donation field and the targeted collection amount are fixed, and selects the winner among the donors when the contribution amount reaches the targeted collection amount so that the collection amount can be donated in the name of the winner to the beneficiary falling in the donation field, a small sum donor can donate a desired sum of money without a burden to the contribution and can make the donation to each field by specifying the fields in which the contribution amount will be used.

Also, according to the present invention, as the donation is performed in the name of the winner selected among the small sum donors, the name of the representative donor, namely, the name of the winner or the details of donations can be provided to the beneficiary, and as the information about the community service is provided to the donor terminals of the donors who donate to the same donation field, the donors who are interested in the same donation field can form high fellowship and exchange information so the donation culture can spread.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a view illustrating the configuration of a system capable of implementing a method of providing a sectorial donation service for a small sum donor according to one exemplary embodiment of the present invention;

FIG. 2 is a flow chart illustrating the method of providing the sectorial donation service for the small sum donor according to the one exemplary embodiment of the present invention;

FIG. 3 is a view illustrating an example of a user terminal from which donation foundation information is output, in the method of providing the sectorial donation service for the small sum donor according to the one exemplary embodiment of the present invention;

FIG. 4 is a view illustrating an example of a user terminal from which information about a virtual donation foundation and a contribution is input, in the method of providing the sectorial donation service for the small sum donor according to the one exemplary embodiment of the present invention;

FIG. 5 is a view illustrating an example of a donor terminal from which a monitor for the confirmation of donation information for the registration of a donor is output, in the method of providing the sectorial donation service for the small sum donor according to the one exemplary embodiment of the present invention;

FIG. 6 is a view illustrating an example of a winner terminal at which an notification message for the selection of the winner arrives, in the method of providing the sectorial donation service for the small sum donor according to the one exemplary embodiment of the present invention;

FIG. 7 is a view illustrating an example of a winner terminal from which the list of donation recipients is output, a in the method of providing the sectorial donation service for the small sum donor according to the one exemplary embodiment of the present invention; and

FIG. 8 is a view illustrating an example of a donor terminal in which a donation confirmation note is received, in the method of providing the sectorial donation service for the small sum donor according to the one exemplary embodiment of the present invention.

### DESCRIPTION OF REFERENCE NUMERALS

10: Virtual donation foundation

11: Donation field

12: Targeted collection amount

100: Service provision server

200: User terminal

210: Donor terminal

220: Winner terminal

S100: Opening a virtual donation foundation for which a donation field and a targeted collection amount are fixed

S200: Transmitting donation foundation information to a user terminal

S300: Receiving information about selection of the virtual donation foundation and a contribution amount inputted from the user terminal and registering the user as a donor when payment for the contribution amount is completed

S400: Providing information about a community service for the virtual donation foundation to a donor terminal

S500: Selecting a winner among donors when the collection amount reaches the targeted collection amount

S600: Receiving information about a beneficiary inputted from a winner terminal

S700: Performing donation of the collection amount in the name of the winner to the beneficiary

S800: Transmitting a donation confirmation note received from the beneficiary to the donor terminal

S900: Transmitting a business report received from the beneficiary to the donor terminal

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. While those skilled in the art could readily devise many other varied embodiments that incorporate the teachings of the present invention through the addition, modification or deletion of elements, such embodiments may fall within the scope of the present invention. In the following description, it is to be noted that, when the functions of conventional elements and the detailed description of elements related with the present invention may make the gist of the present invention unclear, a detailed description of those elements will be omitted. Also, in the drawings, the same reference numerals will be used throughout to designate the same or like components.

Furthermore, it will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Also, it will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof

In the drawings, the shapes and dimensions may be exaggerated for clarity, and the same reference numerals will be used throughout to designate the same or like components.

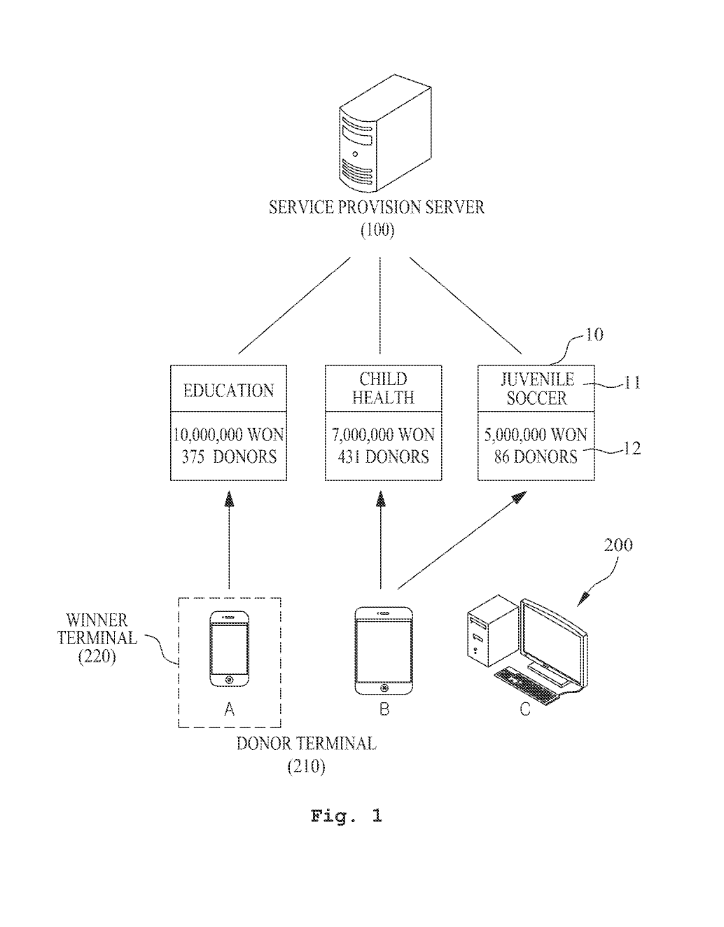

FIG. 1 is a view illustrating the configuration of a system capable of implementing a method of providing a sectorial donation service for a small sum donor according to one exemplary embodiment of the present invention. As illustrated in FIG. 1, a system capable of implementing a method of providing a sectorial donation service for a small sum donor according to one exemplary embodiment of the present invention may be configured to include a service provision server 100 and a user terminal 200.

That is, the service provision server 100 opens at least one virtual donation foundation 10 for which a donation field 11 and a targeted collection amount 12 are fixed, and allows donation of the collection amount in the name of a winner to a beneficiary falling in the donation field 11 by selecting the winner among donors when the total amount of contributions paid by the donors reaches the targeted collection amount. As such, a small sum donor makes a donation to the virtual donation foundation 10 of the donation field 11 desired by the small sum donor, thereby enabling the donor to donate the contribution amount to each field by specifying the fields in which the contribution will be used.

Also, since the donation is made in the name of a winner by selecting the winner among small sum donors, the name of a representative donor, namely, the name of the winner, the details of donations or the like may be provided to the beneficiary. Furthermore, as information about a community service is provided to the donors who donate to the virtual donation foundation 10 of the same donation field 11, the donors who are interested in the same donation field 11 can have high fellowship and exchange information so that a culture of donation can spread.

On the other hand, in the present exemplary embodiment of the invention, the virtual donation foundation 10 refers to a kind of virtual account for which the donation field 11 and the targeted collection amount 12 are fixed, and the collection amount may be donated to the beneficiary who is one of the donation recipients falling in the donation field 11 when the fixed targeted collection amount 12 meets its goal. At this time, the donation recipients who fall in the donation field 11 may be determined in advance by an operator of the service provision server 100, or may be added or modified by the donor' request. Also, the targeted collection amount 12 may be determined in advance by the operator of the service provision server 100 and may be changed depending on the time of opening the virtual donation foundation 10 or the time of collecting money for charity.

Hereinafter, respective elements that constitute the system capable of implementing the method of providing a sectorial donation service for a small sum donor according to the one exemplary embodiment will be explained in detail.

The service provision server 100 may be a server configured to provide a donation service so as to enable a user to make a donation. The service provision server 100 may open at least one virtual donation foundation 10 and may enable donors to donate the total amount of contributions (hereinafter referred to as “the collection amount”) donated by the donors to the virtual donation foundation 10 in the name of a winner selected from the donors to a beneficiary falling in the donation field 11. As such, as the service provision server 100 allows the donation of the collection amount, the users may donate a small sum to their desired fields. Furthermore, even though the donation is performed in a small sum, when one of the donors is selected as a winner, the donation is performed in the name of the selected winner, thereby increasing the donors' desires to donate.

The user terminal 200 may be a terminal owned by a user who desires to make a donation to a specific field using the donation service provided by the service provision server 100. As illustrated in FIG. 1, the users who select the virtual donation foundation 10 and pay the amount of donations become donors. Since a winner among the donors is selected when the collection amount reaches the targeted collection amount 12, a part of the user terminal 200 becomes a donor terminal 210, and one of the donor terminals 210 may be a winner terminal 220.

The present exemplary embodiment of the invention relates to the method of providing the donation service online. The user terminal 200 may be various communication terminals such as computers, notebooks, netbooks, PDAs, an MP4 player, etc., or various smart devices such as smart phones, smart notes, tablet PCs, smart TVs, etc. However, the user terminal 200 in the present exemplary embodiment of the invention is not limited to the terminals as described above. If a terminal can be connected to the service provision server 100 via the interne, intranet, wire a wired and wireless communication network, a mobile communication network, etc. so as to enable the user to select the virtual donation foundation 10 and pay a contribution amount, the terminal may serve as the user terminal 200 regardless of the detailed form of the terminal.

In particular, the user terminal 200 in the present exemplary embodiment of the invention may be a smart device in which an application program for implementing the method of providing the sectorial donation service for the small sum donor according to the present exemplary embodiment of the invention is installed. As the user exercises the application program of the user terminal 200, the user can be provided with various interfaces to facilitate confirmation for various kinds of information about the virtual donation foundation 10 and the present situation of collections, and the payment of contributions.

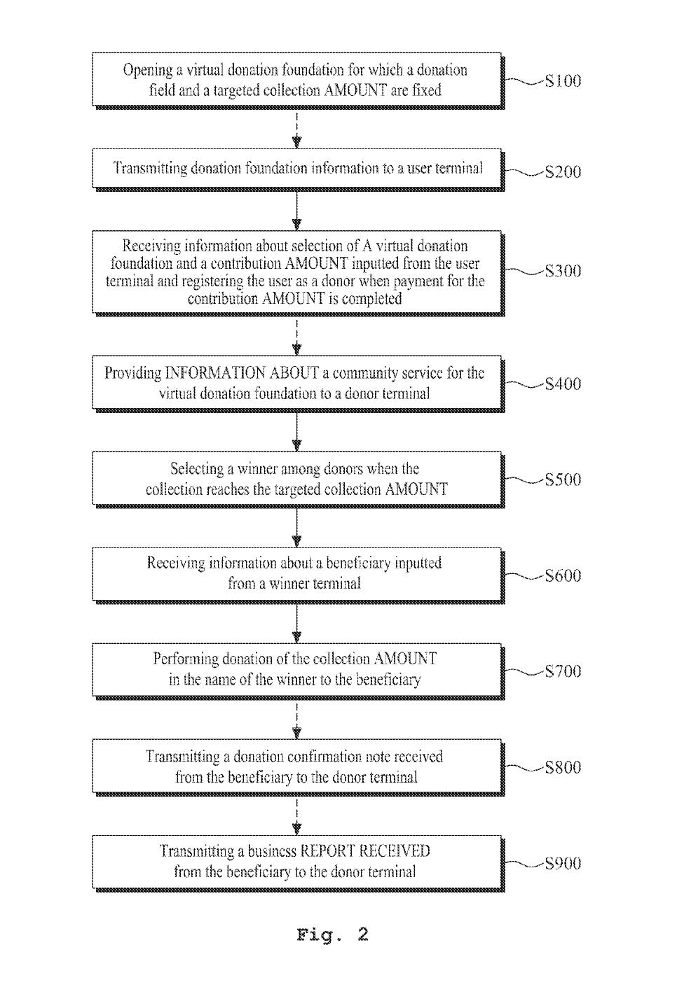

FIG. 2 is a flow chart illustrating the method of providing the sectorial donation service for the small sum donor according to the one exemplary embodiment of the present invention. As illustrated in FIG. 2, the method of providing the sectorial donation service for the small sum donor according to the one exemplary embodiment of the present invention may comprise: opening the virtual donation foundation 10 for which the donation field 11 and the targeted collection amount 12 are fixed (S100); receiving information about selection of the virtual donation foundation 10 and a contribution amount inputted from the user terminal 200, and registering the user as a donor when payment for the contribution amount is completed (S300); selecting a winner among registered donors when the collection amount reaches the targeted collection amount 12 (S500); receiving information about a beneficiary inputted from a winner terminal 220 (S600); and performing donation of the collection amount in the name of the winner to the beneficiary (S700). Also, the method may further comprise: transmitting information about the donation foundation to the user terminal 200 (S200); providing information about a community service for the virtual donation foundation 10 to the donor terminal 210 (S400); receiving a confirmation note of the donation from the beneficiary and transmitting it to the donor terminal 210 (S800); and transmitting a business report received from the beneficiary to the donor terminal 210 (S900).

In step S100, the service provision server 10 may open the virtual donation foundation 10 for which the donation field 11 and the targeted collection amount 12 are fixed. That is, as the targeted collection amount and the donation field 11 to which the collection amount will be donated are fixed for the virtual donation foundation 10, the user can select the donation field 11 desired by the user and can donate thereto. The virtual donation foundation 10 opened in step S100 may be a kind of virtual account, and when the user pays a contribution amount, the contribution amount may be saved in the virtual donation foundation 10.

Meanwhile, the service provision server 100 may open the virtual donation foundation 10 by selecting the targeted collection amount 12 for the donation field 11 to which many people donate, or may open the virtual donation foundation according to the user's request. At this time, in order to induce many users' participation in donation, the service provision server 100 may open the virtual donation foundation 10 with regard to the donation field 11 showing a vote exceeding a predetermined value by taking the vote for each donation field 11.

In step S200, the service provision server 100 may transmit donation foundation information including information about the donation field 11 and the targeted collection amount 12 of the virtual donation foundation 10. That is, to enable the user to easily select the virtual donation foundation 10 to which the user wants to donate, the service provision server 100 may transmit the donation foundation information to the user terminal 200. The donation foundation information may include various kinds of information such as a collection collected at the time of performing step S200, the number of participating donors, period of collection, donation recipient falling in the donation field 11, etc. as well as information about the donation field 11 and the targeted collection amount 12, which is of help to induce the users' participation in donation.

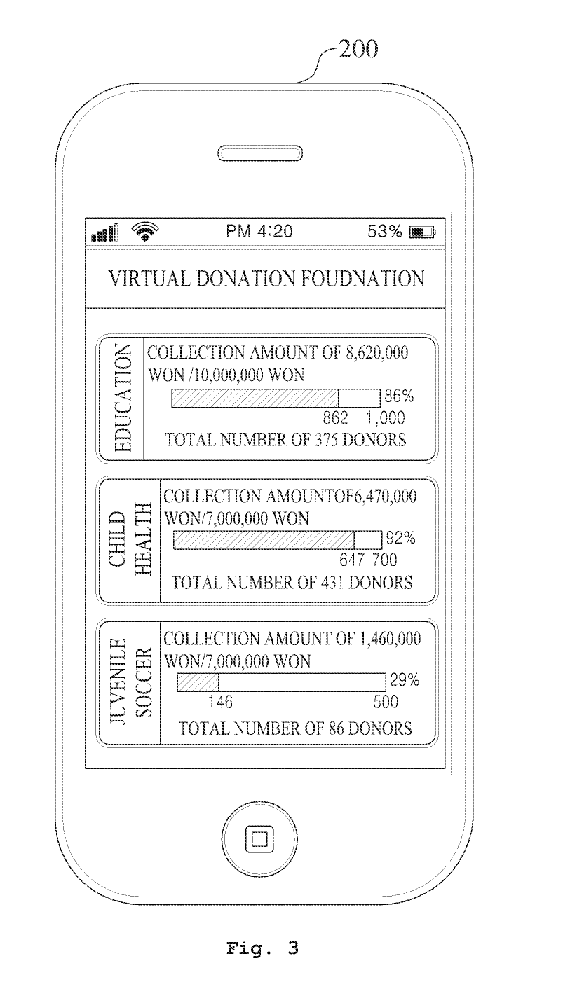

FIG. 3 is a view illustrating an example of the user terminal 200 from which the donation foundation information is output, in the method of providing the sectorial donation service for the small sum donor according to the one exemplary embodiment of the present invention. As illustrated in FIG. 3, in step S200 of the method of providing the sectorial donation service for the small sum donor according to the one exemplary embodiment of the present invention, the donation foundation information including the donation field 11 divided into each field such as “education,” “child health,” “juvenile soccer,” etc. according to each virtual donation foundation 10 may be provided to the user terminal 200. Information about the targeted collection amount 12 and a currently collected collection amount, the total number of donors involved in the donation, etc. may be further provided. Also, when the user selects the specific virtual donation foundation 10, he or she can be provided with more detailed information such as a list of donation recipients falling in the donation field 11 of the corresponding virtual donation foundation 10, an explanation on the donation field 11, the necessity of donation and the like.

In step S300, the service provision server 100 may receive information about selection of the virtual donation foundation 10 and a contribution amount inputted from the user terminal 200 and may register the user as a donor when payment for the contribution is completed. That is, when the user, who has confirmed the donation foundation information in step S200, selects the virtual donation foundation 10, inputs the contribution amount which will be donated to the selected virtual donation foundation 10, and then completes the payment for the inputted contribution amount, the service provision server 100 may register the user as the donor into a database.

At this time, the contribution amount of step S300 may be less than a predetermined rate of the targeted collection amount 12. For example, an upper limit of the contribution amount may be 10%, and when the targeted collection amount 12 is one million won, the contribution amount may be less than 100,000 won. Also, in order to meet the purpose of the method of providing the sectorial donation service for the small sum donor according to the one exemplary embodiment of the present invention, an operator of the service provision server 100 may set up an upper limit of the contribution amount. Meanwhile, the payment for the contribution amount may be performed using various payment processes such as credit card payment, account transfer, cellular payment, point payment, etc. which are available in general online shopping malls.

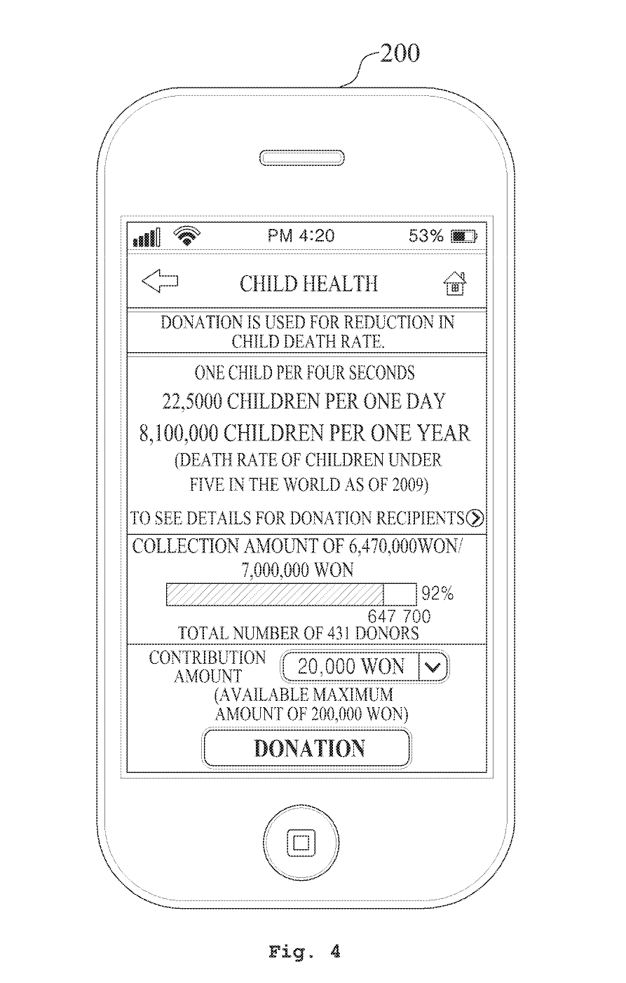

FIG. 4 is a view illustrating an example of the user terminal 200 from which the virtual donation foundation 100 and the contribution are input, in the method of providing the sectorial donation service for the small sum donor according to the one exemplary embodiment of the present invention. As illustrated in FIG. 4, in step S300 of the method of providing the sectorial donation service for the small sum donor according to the one exemplary embodiment of the present invention, the user may input the virtual donation foundation 10 selected by the user and the contribution, and may make the donation using “a donation” button. For example, in the monitor as illustrated in FIG. 3, the user may select the virtual donation foundation 10 in the field of “child health” and may input the contribution of “20,000 won” as shown in the monitor illustrated in FIG. 4. At this time, to prevent an error from being generated at the time of inputting the contribution amount, the upper limit of the contribution amount which is a maximum sum of money being available for donation may be presented. When the user selects “the donation” button, a payment window for payment of the contribution is output, so that a payment process for the contribution may be carried out through the payment window.

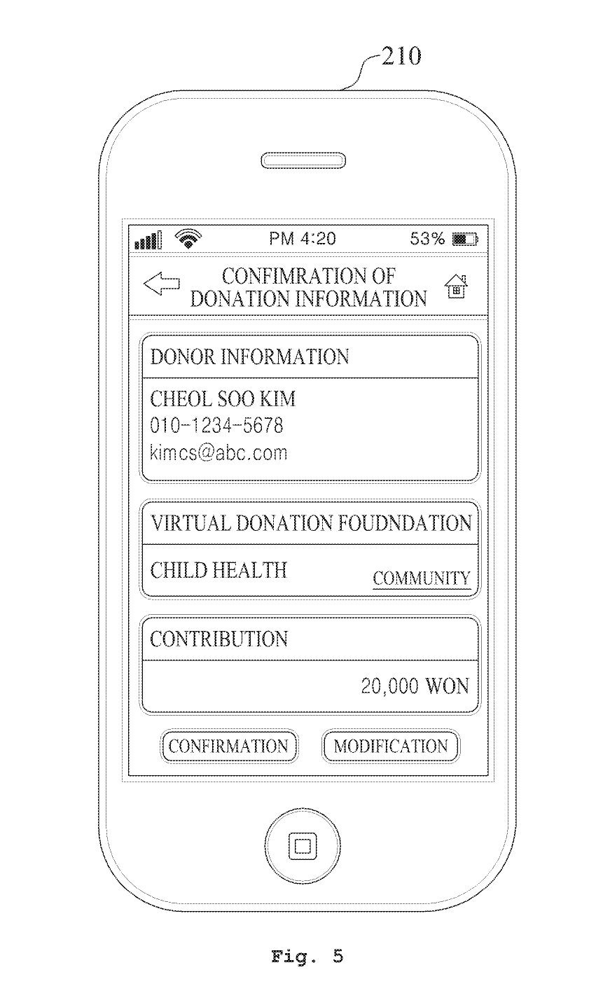

FIG. 5 is a view illustrating an example of the donor terminal 210 from which the monitor for the confirmation of donation information to register donors is output, in the method of providing the sectorial donation service for the small sum donor according to the one exemplary embodiment of the present invention. As illustrated in FIG. 5, in step S300 of the method of providing the sectorial donation service for the small sum donor according to the one exemplary embodiment of the present invention, when the payment process is completed, the user who donates the contribution may confirm user and donation information so that the user can be registered as the donor in the database. Examples of the information, which is required for the user's confirmation, may be the user information including the name and contact number of the donor, etc. and the donation information including the selected virtual donation foundation 10, the contribution amount, etc. When there is any wrong information, the user may modify the wrong information such as the user information using “a modification” button.

In step S400, the service provision server 100 may provide information about the community service concerning the virtual donation foundation selected in the donor terminal 210 of the registered donor in step S300. For example, in the monitor as illustrated in FIG. 5, when the user selects an item “to go to the community,” the user who donates to the virtual donation foundation 10 in the field “Child Health” may use the information about the community service provided to the donor terminal 210. The donors, who donate to the same virtual donation foundation 10, may have interest in the same donation field 11 and may have high fellowship. As the donors use the information about the community service provided in step S400, the fellowship may grow stronger. Furthermore, as the donors share various kinds of information on donations, it may be possible to induce the more active participation of donation.

In step S500, the service provision server 100 may select a winner among the registered donors when the total amount of contributions (namely, “the collection amount”) reaches the targeted collection amount 12. The selection of the winner may be performed using a random number generator, etc. At this time, in step S500, a probability that one of the donors will be selected as the winner may be proportional to the contribution amount paid by the donor. For example, when the targeted collection amount 12 is one million won, a donor who donates the contribution amount of 30,000 won may have a winning probability of 3%.

Meanwhile, in step S500, the user information of the selected winner may be registered in a list of the winners of the virtual donation foundation 10, and the targeted collection amount 12 may be initiated. That is, as the selected winner is registered in the list of winners in the database, in step S700 which will be explained later, the collection amount saved by that time may be donated in the name of the registered winner, and as the targeted collection amount 12 is initiated to zero, the collection amount may be restarted. Also, in a case where the collection amount fails to reach the targeted collection amount 12 during a predetermined period, the period may be extended, so that the collection is performed. However, a winner among the donors who donates by that time may be selected, and the collection amount saved by that time may be donated.

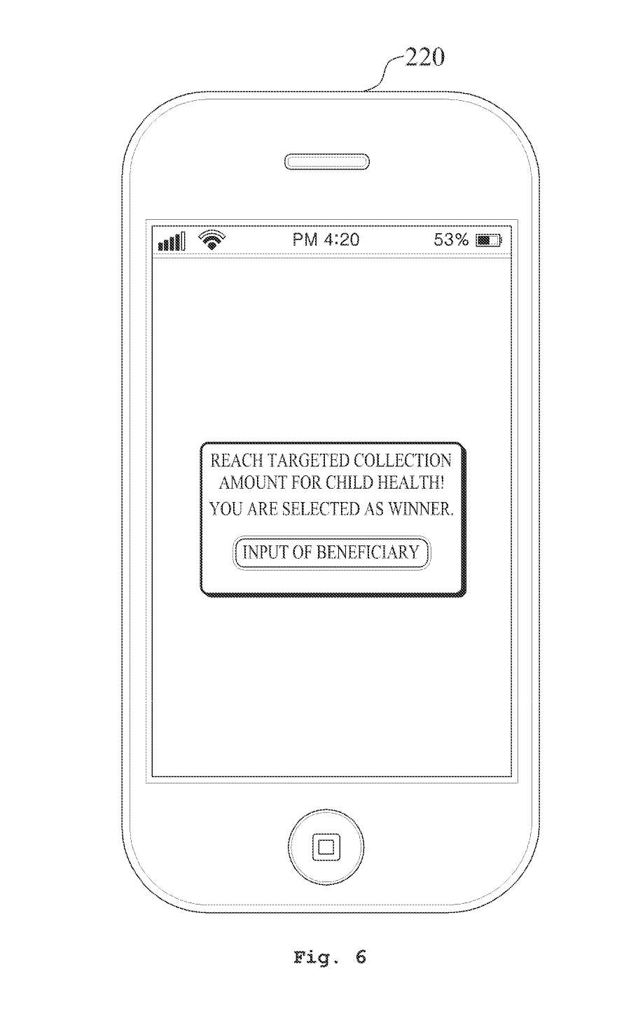

FIG. 6 is a view illustrating an example of the winner terminal 220 at which a notification message for the selection of the winner arrives, in the method of providing the sectorial donation service for the small sum donor according to the one exemplary embodiment of the present invention. As illustrated in FIG. 6, in step S500 of the method of providing the sectorial donation service for the small sum donor according to the one exemplary embodiment of the present invention, the notification message for the selection of the winner may be transmitted to the winner terminal 220 of the donor selected as the winner. The notification message for the selection of the winner may include the message notifying that the collection amount for the virtual donation foundation 10 donated by the winner reaches the targeted collection amount 12 so that the donation can be exercised, and that the donor is selected as the winner. As illustrated in FIG. 6, the notification message for the selection of the winner is transmitted in a push message form so that the winner can immediately recognize it. In addition to that, the notification message for the selection of the winner may be transmitted by e-mail or via a short message service (SMS), a social network service (SNS), a multi message service (MMS) or the community service provided in step S400.

In step S600, the service provision server 100 may receive information about a beneficiary selected among donation recipients falling in the donation field 11 of the virtual donation foundation 10 selected in step S300 inputted from the winner terminal 220. Many donation recipients who need the donation may be included in the donated field fixed in the virtual donation foundation 10. In step S600, the winner may select any one of the donation recipients as the beneficiary or may input the beneficiary by directly inputting the donation recipient falling in the donation field 11.

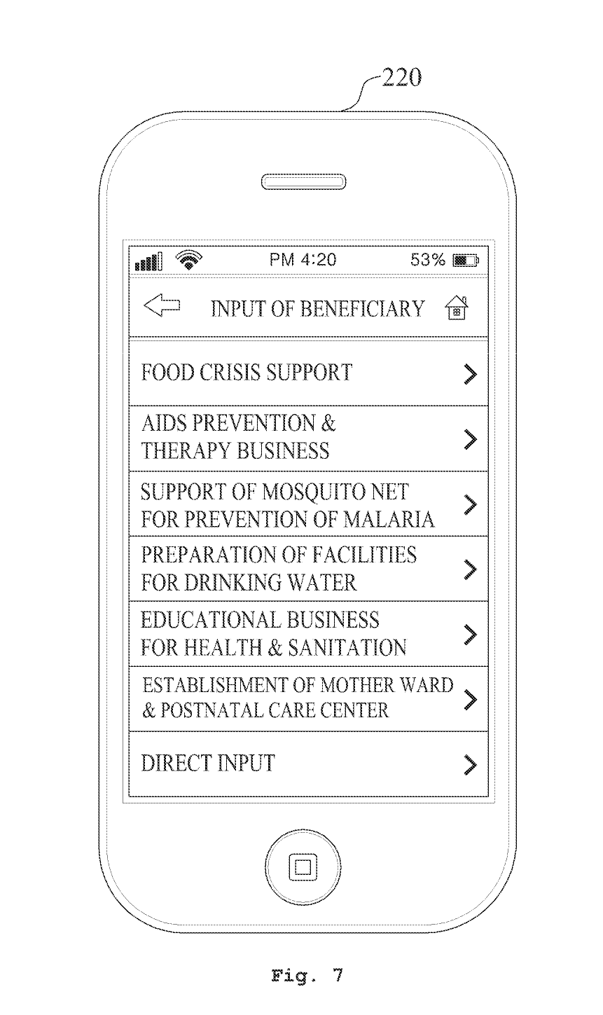

FIG. 7 is a view illustrating an example of the winner terminal 220 from which the list of donation recipients is output, in the method of providing the sectorial donation service for the small sum donor according to the one exemplary embodiment of the present invention. As illustrated in FIG. 7, in step S600 of the method of providing the sectorial donation service for the small sum donor according to the one exemplary embodiment of the present invention, the service provision server 100 may transmit the list of the donation recipients falling in the donation field of the virtual donation foundation 11 to the winner terminal 220. The winner may input information about selection of the beneficiary who will receive the donation by selecting any one of the list.

In step S700, the service provision server may perform donation of the collection amount in the name of the winner to the inputted beneficiary. That is, the service provision server 100 may perform the donation of the collection amount in the name of the winner to the beneficiary selected by the winner in step S600. At this time, in step S700, a fee may be charged at a predetermined rate of the collection amount, and the remaining amount of collection may be donated in the name of the winner to the beneficiary. For example, in a case where the fee charged by the service provision server 100 is 5% of the collection amount, that is, when the collection amount is one million won, the fee becomes 50,000 won, and the sum donated to the beneficiary in step S700 may be 950,000 won.

In step S800, the service provision server 100 may receive a confirmation note from the beneficiary who receives the donation in step S700 and may transmit it to the donor terminal 210 of the donor registered in step S300. That is, the service provision server 100 may receive the donation confirmation note according to the details donated in step S700 and transmit it to the donor terminal 210 of the donor who makes really the donation. As a result, the donor can specifically confirm how much collection in total amount is collected, and what beneficiary receives the collection amount, and can also confirm that the collection amount is properly donated to the donation field selected by the donor, thereby enabling the donor to participate in donation with an easy mind

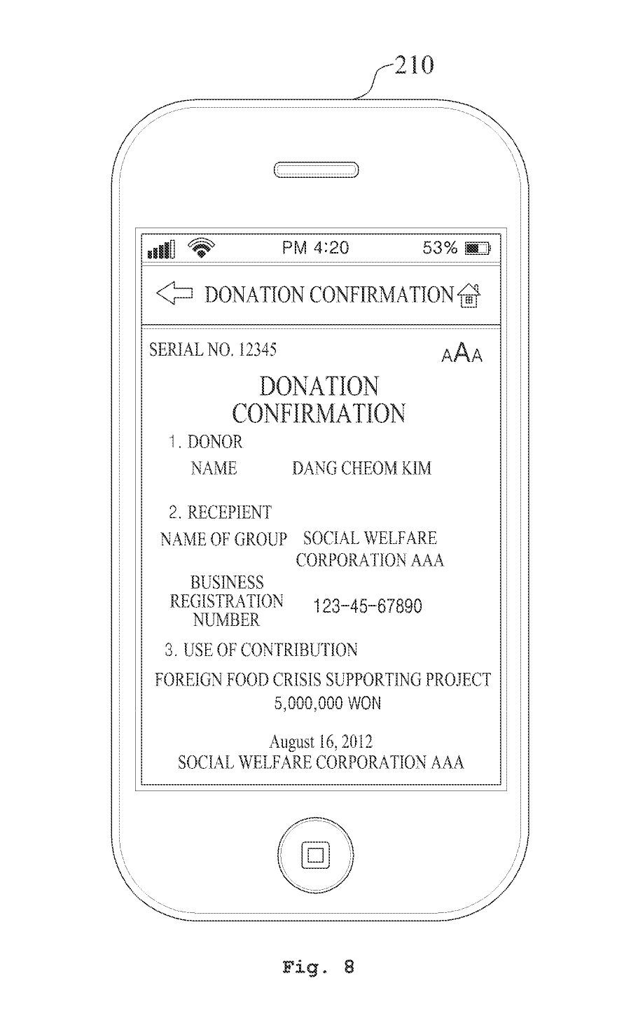

FIG. 8 is a view illustrating an example of the donor terminal 210 in which the donation confirmation note is received, in the method of providing the sectorial donation service for the small sum donor according to the one exemplary embodiment of the present invention. As illustrated in FIG. 8, in step S800 of the method of providing the sectorial donation service for the small sum donor according to the one exemplary embodiment of the present invention, the winner (“donor” in FIG. 8) who is a nominee of the donation, the beneficiary (“recipient” and “place for usage of the collection amount”), the collection amount (“5,000,000 won”), etc. may be confirmed. That is, the beneficiary may be specific groups, individuals or the like such as a welfare center or a protection center for abandoned dogs which directly receive the contribution amount, or may be a group which performs a supporting business for a person who gets a benefit. In these groups, since various businesses may be simultaneously performed, the donation confirmation note should concretely describe information about the beneficiary so that the donor can clearly confirm whether or not the donation is performed with the donation field 11 desired by the donor.

In step S900, the service provision server 100 may transmit a business report received from the beneficiary who received the donation in step S700 to the donor terminal 210 of the donor registered in step S300. That is, in step S800, the donation confirmation note showing the fact that the donation has been performed may be transmitted to the donor terminal 210, and in step S900, the business report showing how the donated collection amount has been used may be received and the business report may be transmitted to the donor terminal 210. As step S900 is carried out, a reliability of the method of providing the sectorial donation service for the small sum donor according to the one exemplary embodiment of the present invention can be improved, and the users' participation rate in donating can be also improved.

While the present invention has been shown and described in connection with the exemplary embodiments, it will be apparent to those skilled in the art that modifications and variations can be made without departing from the spirit and scope of the invention as defined by the appended claims.

What is claimed is:

1. A method of providing a sectorial donation service for a small-sum donor, which is performed using a service provision server that provides a donation service so as to enable a user to make a donation, the method, comprising:
(1) opening a virtual donation foundation for which a donation field and a targeted collection amount are fixed;
(2) receiving information about selection of the virtual donation foundation and a contribution amount inputted from a user terminal and registering the user as a donor when payment for the contribution amount is completed;
(3) selecting a winner among donors when the total amount of contributions (hereinafter referred to as, “the collection amount”) reaches the targeted collection amount;
(4) receiving information about a beneficiary among donation recipients falling in the donation field of the virtual donation foundation selected in the step (2) inputted from a winner terminal of the selected winner; and
(5) performing donation of the collection amount in the name of the winner to the inputted beneficiary.

2. The method of claim 1, further comprising:
transmitting donation foundation information including information on the donation field and the targeted collection amount of the virtual donation foundation opened in the step (1) to the user terminal, which is performed between the steps (1) and (2).

3. The method of claim 1, wherein the contribution amount of the step (2) is less than a predetermined rate of the targeted collection amount.

4. The method of claim 1, further comprising:
providing information about a community service for the selected virtual donation foundation to the donor terminal of the donor registered in the step (2) after the step (2) has been performed.

5. The method of claim 1, wherein a probability that one of donors will be selected as the winner in the step (3) is proportional to the contribution amount paid by the donor.

6. The method of claim 1, wherein in the step (3), user information of the selected winner is registered in a list of winners of the virtual donation foundation, and the targeted collection amount is initialized.

7. The method of claim 1, wherein in the step (5), a fee may be charged at the predetermined rate of the collection amount, and the remaining amount of the collection is donated in the name of the winner to the beneficiary.

8. The method of claim 1, further comprising:
transmitting a confirmation note received from the beneficiary who receives the donation in the step (5) to the donor terminal for the donor registered in the step (2) after the step (5) has been completed.

9. The method of claim 1, further comprising:
transmitting a business report received from the beneficiary who receives the donation in the step (5) to the donor terminal for the donor registered in the step (2) after the step (5) has been completed.
